(19) United States
(12) Patent Application Publication
(10) Pub. No.: US 2015/0292764 A1
(43) Pub. Date: Oct. 15, 2015

(54) RECONFIGURABLE NETWORK CONTROLLER

(71) Applicant: Trane International Inc., Piscataway, NJ (US)

(72) Inventors: Joseph George Land, III, Tyler, TX (US); Kit W. Klein, Tyler, TX (US)

(21) Appl. No.: 14/683,956

(22) Filed: Apr. 10, 2015

Related U.S. Application Data
(60) Provisional application No. 61/978,066, filed on Apr. 10, 2014.

(51) Int. Cl. F24F 11/00; H04L 12/28; G05B 15/02; H04L 29/08

(52) U.S. Cl. CPC F24F 11/006; H04L 67/12; H04L 12/282; G05B 15/02

(57) ABSTRACT

A computing device, such as a thermostat, may be structured to communicate with a network access device via a first protocol and communicate with a plurality of home automation devices via a second protocol. The computing device may also be structured to operate as a primary controller or a repeater device in a home automation system. The computing device may receive information from a server instructing the computing device to operate as the primary controller or the repeater device. Or, the computing device may determine itself whether to operate as the primary controller or repeater device.

### BACKGROUND

The present invention generally relates to a reconfigurable network controller in, for example, a home automation system. Home automation systems may be controlled in various ways. Some existing systems have various shortcomings relative to certain applications. Accordingly, there remains an interest for further contributions in this area of technology.

### SUMMARY

One embodiment of the present invention is a unique reconfigurable network controller. Other embodiments include apparatuses, systems, devices, hardware, methods, and combinations for a reconfigurable network controller. Further embodiments, forms, features, aspects, benefits, and advantages of the present application shall become apparent from the description and figures provided herewith.

### BRIEF DESCRIPTION OF THE DRAWINGS

The description herein makes reference to the accompanying figures wherein like reference numerals refer to like parts throughout the several views, and wherein:

FIG. 1 is a schematic diagram of an exemplary system.

FIG. 2 is a schematic diagram of an exemplary computing device.

FIG. 3 is a flow diagram of an exemplary process for configuring a computing device.

### DETAILED DESCRIPTION OF EXEMPLARY EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is hereby intended. Any alterations and further modifications in the described embodiments, and any further applications of the principles of the invention as described herein are contemplated as would normally occur to one skilled in the art to which the invention relates.

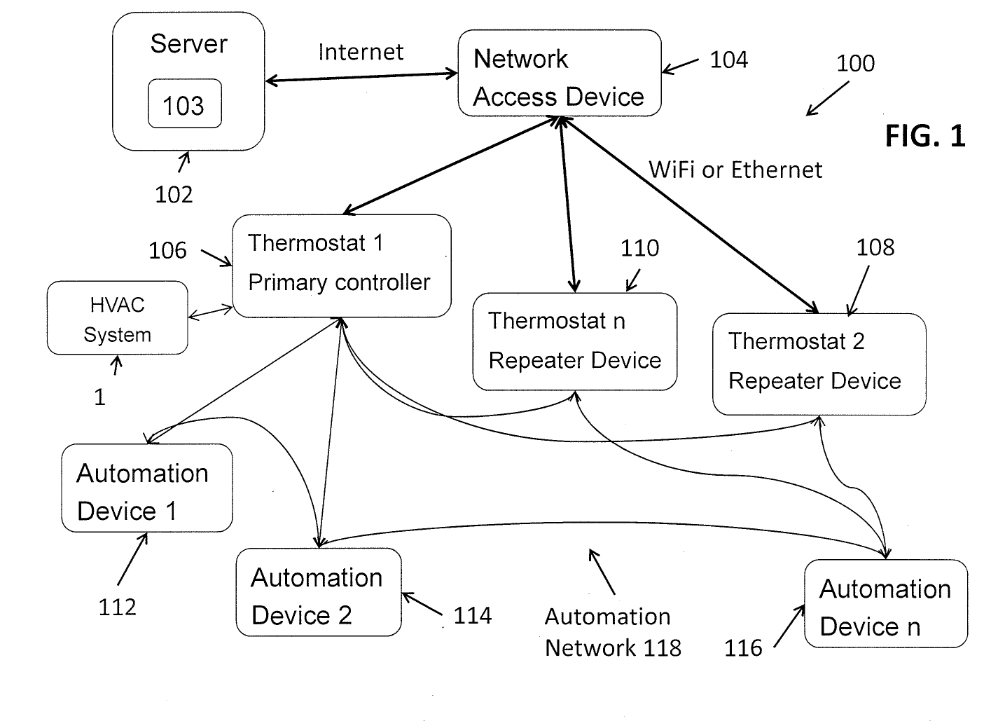

FIG. 1 illustrates an exemplary system 100 including a server 102, a network access device 104 (e.g., a router), a first thermostat 106, a second thermostat 108, an nth thermostat 110, a first automation device 112, a second automation device 114, and an nth automation device 116. In the embodiment shown in FIG. 1, the first thermostat 106 is configured as a primary controller or network controller for an automation network 118 such as a Z-Wave or Zigbee network. The various automation devices 112, 114, 116 may be any type of automation device such as a camera module, a light module, a lock, a motion sensor, a door sensor, a window sensor, a power receptacle module, a home appliance module, a security alarm keypad, a smart appliance, and a garage door opener.

The first thermostat 106 includes one or more wireless transceivers that allow the first thermostat 106 to communicate via two or more protocols. The first thermostat 106 may communicate with the network access device 104 via the first protocol such as WiFi or Ethernet. The first thermostat 106 may communicate with the automation portal 103 at the server 102 via the network access device 104.

The first thermostat 106 may communicate with the other thermostats 108, 110, and the automation devices 112, 116, 118 via the second protocol over automation network 118, which may be a mesh network (e.g., Z-Wave or Zigbee). The first thermostat 106, and the other thermostats 108, 110 may be structured to control at least a portion of a heating, ventilation, and air conditioning (HVAC) system 120 in a building such as a home or commercial building.

As seen in FIG. 1, the system 100 may include more than one thermostat, but the system 100 may only need one primary controller. The thermostats 108, 110 may be repurposed from being primary controllers to repeater nodes in the automation network 118, which may strengthen the overall mesh network.

When a thermostat is enrolled at server 102, automation portal 103, which may include centralized control software, determines if a primary controller is already enrolled in the system 100. If not, the automation portal 103 will send a command or configuration information to that thermostat so that it is enrolled as both a thermostat (via the WiFi or Ethernet connection to network access device 104) and as the primary controller for the automation network 118. If a primary controller already exists in the system (either from a different thermostat, or a standalone bridge) the automation portal 103 will transmit a command or configuration data to instruct the thermostat to convert from a primary controller to a repeater node and then the automation portal 103 may automatically (without any additional user interaction) enroll that repeater node into the existing primary controller. The thermostats 108 and 110 may also be structured to communicate with the automation portal 103 at the server 102 via the network access device 104.

In some embodiments, the first thermostat 106 enrolled or added to an automation account at the server 102 will be configured as to operate as the primary controller or bridge on the account. When operating as the primary controller, the first thermostat 106 is a communications gateway that receives information from automation network devices (e.g., a door sensor indicating a door was opened), then passes this information to the network access device 104 using, for example, Wi-Fi so that this information can be displayed at the automation portal 103 at the server 102. Changes made to any of the automation devices 112, 114, 116 at the automation portal 103 are sent to the primary controller (which is the first thermostat 106 in FIG. 1) via the Internet. The first thermostat 106 will then broadcasts the request to the automation devices 112, 114, 116 via the automation network 118 using a mesh network such as Z-Wave or Zigbee.

If more than one thermostat added to an account, or a thermostat is added to an account with an existing primary controller or bridge, the additional thermostats 108, 110 will be configured as automation network repeaters. An automation network repeater typically improves communications between devices in an automation network such as a mesh network.

It is contemplated that in some embodiments, the thermostat 106 may automatically determine whether it should be configured as the primary controller or a repeater device based on whether a primary controller is already installed in the system.

Furthermore, it is contemplated that in some embodiments, any of the various automation devices 112, 114, 116 may be configured to be the primary controller or a repeater device like the first thermostat 106 as shown in FIG. 1.

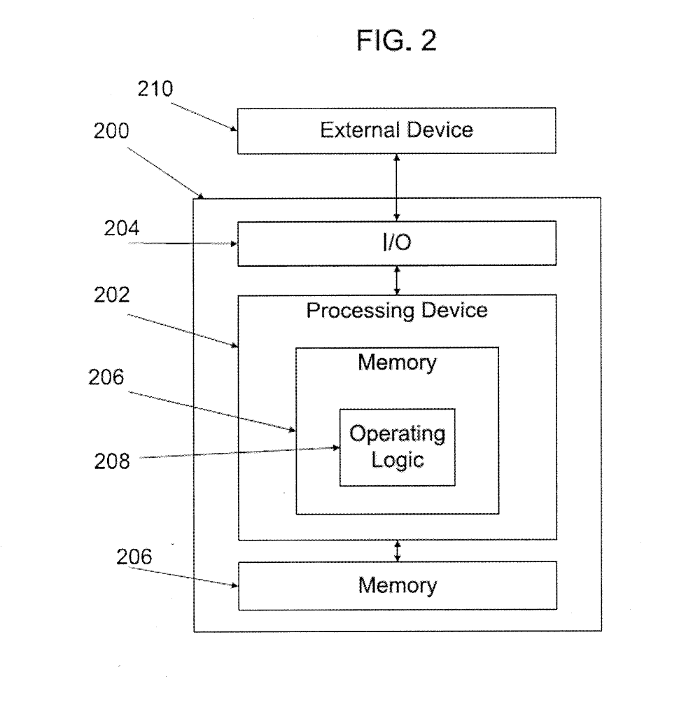

FIG. 2 is a schematic block diagram of a computing device 200. The computing device 200 is one example of a server, thermostat, or automation device configuration that may be utilized in connection with the server 102, thermostats 106, 108, 110, or automation devices 112, 114, 116 shown in FIG. 1. Computing device 200 includes a processing device 202, an input/output device 204, memory 206, and operating logic 208. Furthermore, computing device 200 communicates with one or more external devices 210.

The input/output device 204 allows the computing device 200 to communicate with the external device 210. For example, the input/output device 204 may be a transceiver, network adapter, network card, interface, or a port (e.g., a USB port, serial port, parallel port, an analog port, a digital port, VGA, DVI, HDMI, FireWire, CAT 5, or any other type of port or interface). The input/output device 204 may be include hardware, software, and/or firmware. It is contemplated that the input/output device 204 will include more than one of these adapters, cards, or ports.

The external device 210 may be any type of device that allows data to be inputted or outputted from the computing device 200. For example, the external device 210 may be a network access device, a thermostat, an automation device, a sensor, mobile device, equipment, a handheld computer, a diagnostic tool, a controller, a computer, a server, a processing system, a printer, a display, an alarm, an illuminated indicator such as a status indicator, a keyboard, a mouse, or a touch screen display. Furthermore, it is contemplated that the external device 210 may be integrated into the computing device 200. It is further contemplated that there may be more than one external device in communication with the computing device 200.

Processing device 202 can be a programmable type, a dedicated, hardwired state machine, or any combination of these. The processing device 202 may further include multiple processors, Arithmetic-Logic Units (ALUs), Central Processing Units (CPUs), Digital Signal Processors (DSPs), or the like. Processing devices 202 with multiple processing units may utilize distributed, pipelined, and/or parallel processing. Processing device 202 may be dedicated to performance of just the operations described herein or may be utilized in one or more additional applications. In the depicted form, processing device 202 is of a programmable variety that executes algorithms and processes data in accordance with operating logic 208 as defined by programming instructions (such as software or firmware) stored in memory 206. Alternatively or additionally, operating logic 208 for processing device 202 is at least partially defined by hardwired logic or other hardware. Processing device 202 may include one or more components of any type suitable to process the signals received from input/output device 204 or elsewhere, and to provide desired output signals. Such components may include digital circuitry, analog circuitry, or a combination of both.

Memory 206 may be of one or more types, such as a solid-state variety, electromagnetic variety, optical variety, or a combination of these forms. Furthermore, memory 206 can be volatile, nonvolatile, or a combination of these types, and some or all of memory 206 can be of a portable variety, such as a disk, tape, memory stick, cartridge, or the like. In addition, memory 206 can store data that is manipulated by the operating logic 208 of processing device 202, such as data representative of signals received from and/or sent to input/output device 204 in addition to or in lieu of storing programming instructions defining operating logic 208, just to name one example. As shown in FIG. 2, memory 206 may be included with processing device 202 and/or coupled to the processing device 202.

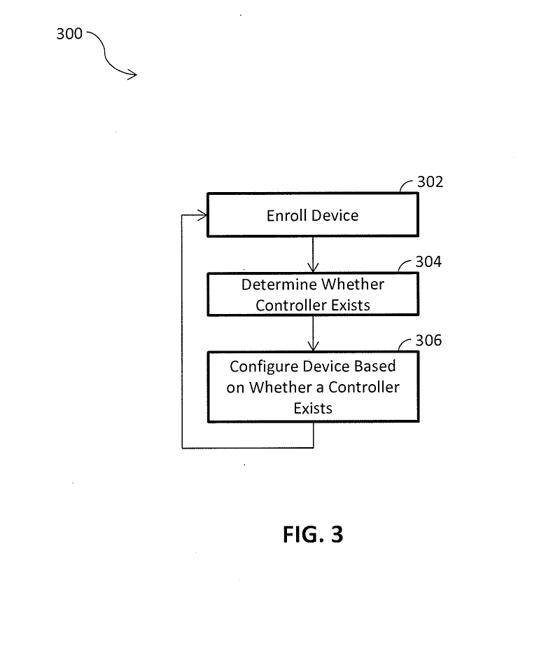

FIG. 3 illustrates a schematic flow diagram of an exemplary process 300 for configuring an automation device (e.g., a thermostat) as a primary controller or as a repeater device. Operations illustrated for all of the processes in the present application are understood to be examples only, and operations may be combined or divided, and added or removed, as well as re-ordered in whole or in part, unless explicitly stated to the contrary.

Process 300 begins at operation 302 in which an automation device such as a thermostat is enrolled with the automation portal 103. For example, a thermostat may be associated with an account for a particular home or business.

Process 300 then proceeds from operation 302 to operation 304. At operation 304, the automation portal 103 checks the current system configuration to determine whether a primary controller is already enrolled at the home or business.

Process 300 then proceeds from operation 304 to operation 306. At operation 306, if the thermostat is the first controller enabled device to enroll (e.g., first thermostat 106), then the primary controller functionality within the thermostat is enabled and designated as the primary controller for the network. For example, the automation portal 103 may send a command or configuration data to enable the primary controller functionality in the first thermostat 106. In addition, a user may be informed that he or she may enroll other automation devices 112, 114, 116 into the first thermostat based controller 106.

However, if a primary controller is already enrolled, then the automation portal 103 may send a command or configuration information to the thermostat (e.g., thermostat 108 or 110) to enable the repeater node functionality. The thermostat may reflash the firmware on the communication chip using the alternate repeater node firmware image stored in the local file system. The thermostat may inform the automation portal 103 once the reflash is successful. The automation portal 103 may then issue an add-node command to the pre-existing primary controller to initiate the inclusion process. The automation portal 103 may then issue an enroll command to the repeater node within the thermostat to initiate enrollment into the primary controller.

The various aspects of the process 300 in the present application may be implemented in operating logic 208 as operations by software, hardware, and/or at least partially performed by a user or operator. In certain embodiments, operations represent software elements as a computer program encoded on a computer readable medium, wherein the server 102 (including automation portal 103) and/or the thermostats 106, 108, or 110 perform the described operations when executing the computer program(s).

It is contemplated that the various aspects, features, computing devices, processes, and operations from the various embodiments may be used in any of the other embodiments unless expressly stated to the contrary.

One aspect of the present application includes a method, comprising: enrolling a thermostat in a home automation system; determining whether a primary controller is enrolled in the home automation system; and configuring the thermostat to be the primary controller if no primary controller is enrolled in the home automation system.

Features of the aspect may include: configuring the thermostat to be a repeater device if the primary controller is already enrolled in the home automation system; reflashing firmware on the thermostat to operate the thermostat as the repeater device; wherein a server determines whether the primary controller is enrolled in the home automation system; wherein the thermostat determines whether the primary controller is enrolled in the home automation system; wherein when the thermostat is configured to be the primary controller, the thermostat is structured to control a plurality of home automation devices in the system; wherein thermostat is structured to communicate with the home automation devices via a mesh network; wherein the mesh network is a Z-Wave network.

Another aspect of the present application includes a computing device, comprising: one or more wireless transceivers structured to communicate via a first protocol and a second protocol; a processing device; a memory including instructions, wherein the instructions when executed by the processing device cause the computing device to: communicate with a network access device via the first protocol; communicate with a plurality of home automation devices via the second protocol; control at least a portion of an HVAC system in a building; and communicate with a Server via the network access device to receive configuration information, wherein the configuration information configures the computing device to operate as one of a primary controller and a repeater device.

Features of the aspect may include: wherein the first protocol is WIFI; wherein the second protocol is Z-Wave; wherein the computing device is a thermostat; wherein the home automation devices include at least one of a camera module, a light module, a lock, a motion sensor, a door sensor, a window sensor, a power receptacle module, a home appliance module, a security alarm keypad, a smart appliance, and a garage door opener; wherein the computing device is configured to operate as the primary controller if no primary controller is enrolled in a home automation system; wherein the computing device is configured to operate as the repeater device if the primary controller is enrolled in a home automation system.

Yet another aspect of the present application includes a system, comprising: a server structured to enroll a thermostat in a home automation network, determine whether a primary controller is enrolled in the home automation network, and transmit a configuration command to the thermostat, wherein the configuration command instructs the thermostat to be the primary controller in the home automation network if no primary controller is enrolled in the home automation network or to be a repeater device if the primary controller is already enrolled in the home automation network, wherein the thermostat is structured to receive the configuration command and automatically configure itself to operate as one of the primary controller and the repeater device in the home automation network based on the configuration command.

Features of the aspect may include: a plurality of home automation devices structured to communicate with the thermostat via the home automation network, wherein the home automation devices include at least one of a camera module, a light module, a lock, a motion sensor, a door sensor, a window sensor, a power receptacle module, a home appliance module, a security alarm keypad, a smart appliance, and a garage door opener; wherein the home automation network is a mesh network.

Another aspect of the present application includes a computing device, comprising: one or more wireless transceivers structured to communicate via a first protocol and a second protocol; a processing device; a memory including instructions, wherein the instructions when executed by the processing device cause the computing device to: communicate with a network access device via the first protocol; communicate with a plurality of automation devices via the second protocol; and automatically reconfigure to operate as one of a primary controller and a repeater device in an automation system.

Features of the aspect may include: wherein the computing device is one of a camera module, a light module, a lock, a motion sensor, a door sensor, a window sensor, a power receptacle module, a home appliance module, a security alarm keypad, a smart appliance, and a garage door opener.

While the invention has been described in connection with what is presently considered to be the preferred embodiment, it is to be understood that the invention is not to be limited to the disclosed embodiment(s), but on the contrary, is intended to cover various modifications and equivalent arrangements. Furthermore it should be understood that while the use of the word “preferable,” “preferably,” or “preferred” in the description above indicates that feature so described may be more desirable, it nonetheless may not be necessary and any embodiment lacking the same may be contemplated as within the scope of the invention. Further, when the language “at least a portion” and/or “a portion” is used the item may include a portion and/or the entire item unless specifically stated to the contrary.

What is claimed is:

1. A method, comprising:
enrolling a thermostat in a home automation system;
determining whether a primary controller is enrolled in the home automation system; and
configuring the thermostat to be the primary controller if no primary controller is enrolled in the home automation system.

2. The method of claim 1, further comprising:
configuring the thermostat to be a repeater device if the primary controller is already enrolled in the home automation system.

3. The method of claim 2, further comprising:
reflashing firmware on the thermostat to operate the thermostat as the repeater device.

4. The method of claim 1, wherein a server determines whether the primary controller is enrolled in the home automation system.

5. The method of claim 1, wherein the thermostat determines whether the primary controller is enrolled in the home automation system.

6. The method of claim 1, wherein when the thermostat is configured to be the primary controller, the thermostat is structured to control a plurality of home automation devices in the system.

7. The method of claim 6, wherein thermostat is structured to communicate with the home automation devices via a mesh network.

8. The method of claim 7, wherein the mesh network is a Z-Wave network.

9. A computing device, comprising:
one or more wireless transceivers structured to communicate via a first protocol and a second protocol;
a processing device;
a memory including instructions, wherein the instructions when executed by the processing device cause the computing device to:
communicate with a network access device via the first protocol;
communicate with a plurality of home automation devices via the second protocol;
control at least a portion of an HVAC system in a building; and
communicate with a server via the network access device to receive configuration information, wherein the configuration information configures the computing device to operate as one of a primary controller and a repeater device.

10. The computing device of claim 9, wherein the first protocol is WIFI.

11. The computing device of claim 9, wherein the second protocol is Z-Wave.

12. The computing device of claim 9, wherein the computing device is a thermostat.

13. The computing device of claim 9, wherein the home automation devices include at least one of a camera module, a light module, a lock, a motion sensor, a door sensor, a window sensor, a power receptacle module, a home appliance module, a security alarm keypad, a smart appliance, and a garage door opener.

14. The computing device of claim 9, wherein the computing device is configured to operate as the primary controller if no primary controller is enrolled in a home automation system.

15. The computing device of claim 9, wherein the computing device is configured to operate as the repeater device if the primary controller is enrolled in a home automation system.

16. A system, comprising:
a server structured to enroll a thermostat in a home automation network, determine whether a primary controller is enrolled in the home automation network, and transmit a configuration command to the thermostat, wherein the configuration command instructs the thermostat to be the primary controller in the home automation network if no primary controller is enrolled in the home automation network or to be a repeater device if the primary controller is already enrolled in the home automation network,
wherein the thermostat is structured to receive the configuration command and automatically configure itself to operate as one of the primary controller and the repeater device in the home automation network based on the configuration command.

17. The system of claim 16, further comprising:
a plurality of home automation devices structured to communicate with the thermostat via the home automation network, wherein the home automation devices include at least one of a camera module, a light module, a lock, a motion sensor, a door sensor, a window sensor, a power receptacle module, a home appliance module, a security alarm keypad, a smart appliance, and a garage door opener.

18. The system of claim 16, wherein the home automation network is a mesh network.

19. A computing device, comprising:
one or more wireless transceivers structured to communicate via a first protocol and a second protocol;
a processing device;
a memory including instructions, wherein the instructions when executed by the processing device cause the computing device to:
communicate with a network access device via the first protocol;
communicate with a plurality of automation devices via the second protocol; and
automatically reconfigure to operate as one of a primary controller and a repeater device in an automation system.

20. The computing device of claim 19, wherein the computing device is one of a camera module, a light module, a lock, a motion sensor, a door sensor, a window sensor, a power receptacle module, a home appliance module, a security alarm keypad, a smart appliance, and a garage door opener.
